(19) United States
(12) Patent Application Publication
(10) Pub. No.: US 2018/0258791 A1
(43) Pub. Date: Sep. 13, 2018

(54) COMPONENT HAVING A HYBRID COATING SYSTEM AND METHOD FOR FORMING A COMPONENT

(71) Applicant: GENERAL ELECTRIC COMPANY, Schenectady, NY (US)

(72) Inventors: Srikanth Chandrudu KOTTILINGAM, Greenville, SC (US); Brian Lee TOLLISON, Honea Path, SC (US); David Edward SCHICK, Greenville, SC (US); Yan CUI, Greer, SC (US); Surinder Singh PABLA, Greer, SC (US); Jon Conrad SCHAEFFER, Simpsonville, SC (US)

(21) Appl. No.: 15/455,634

(22) Filed: Mar. 10, 2017

(51) Int. Cl. F01D 25/12; C23C 4/12; C23C 4/04; F01D 25/00

(52) U.S. Cl. CPC F01D 25/12; C23C 4/12; C23C 4/04; F05D 2300/6033; F05D 2220/32; F05D 2260/232; F05D 2300/611; F01D 25/005

(57) ABSTRACT

A component having a hybrid coating system is provided. The component includes a substrate having a surface and a hybrid coating system including a sheet disposed on the surface and a skin. The sheet includes a plurality of interlocking members. The skin includes a plurality of features corresponding to the interlocking members. The skin is engaged to the sheet in an interlocking manner via the interlocking members and the features. A method for forming a component with a hybrid coating system is also disclosed.

### FIELD OF THE INVENTION

The present invention is generally directed to hybrid coating systems and methods for forming the hybrid coating systems. More specifically, the present invention is directed to turbine components and methods forforming the hybrid coated turbine components.

### BACKGROUND OF THE INVENTION

Gas turbines for power generation systems must satisfy the highest demands with respect to reliability, power, efficiency, economy, and operating service life. Modern high-efficiency combustion turbines have firing temperatures that exceed about 2,300° F. (1,260° C.), and firing temperatures continue to increase as demand for more efficient engines continues. Many components that form the combustor and “hot gas path” turbine sections are directly exposed to aggressive hot combustion gases. The use of coatings on turbine components such as combustors, combustion liners, combustion transition pieces, combustion hardware, blades (buckets), vanes (nozzles) and shrouds is important in commercial gas turbine engines.

Coatings, such as thermal barrier coating systems, contribute to desirable performance characteristics and operating capabilities at elevated temperatures. Typical thermal barrier coating systems include a bond coat disposed on the substrate of the turbine component, and a thermally insulating top coating, referred to as the “thermal barrier coating,” disposed on the bond coating. The bond coat provides oxidation and hot corrosion protection to the underlying substrate of the turbine component. However, such coatings require servicing that often require complicated and labor intensive removal of the coating system prior to reapplication of the coating. Such coatings are difficult to remove and some removal techniques are deleterious to the underlying substrate.

### BRIEF SUMMARY OF THE INVENTION

In an exemplary embodiment, a component having a hybrid coating system is provided. The component includes a substrate having a surface and a hybrid coating system including a sheet disposed on the surface and a skin. The sheet includes a plurality of interlocking members. The skin includes a plurality of features corresponding to the interlocking members. The skin is engaged to the sheet in an interlocking manner via the interlocking members and the features.

In another exemplary embodiment, a turbine component having a hybrid coating system is provided. The turbine component includes a substrate having a surface and a hybrid coating system including a sheet disposed on the surface and a skin. The substrate includes a material selected from the group consisting of metal, ceramic matrix composite (CMC), and combinations thereof. The sheet includes a plurality of interlocking members. The ceramic skin having a plurality of features corresponding to the interlocking members. The ceramic skin is engaged to the sheet in an interlocking manner via the interlocking members and the features. The sheet is brazed to the substrate. The component further includes an additional ceramic layer thermally sprayed onto the ceramic skin.

In another exemplary embodiment, a process for forming a component having a hybrid coating system is provided. The process includes providing a substrate having a surface; disposing a sheet on the surface, the sheet having a plurality of interlocking members; providing a ceramic skin having a plurality of features corresponding to the interlocking members; and engaging the ceramic skin to the sheet in an interlocking manner via the interlocking members and the features.

Other features and advantages of the present invention will be apparent from the following more detailed description of the preferred embodiment, taken in conjunction with the accompanying drawings, which illustrate, by way of example, the principles of the invention.

### BRIEF DESCRIPTION OF THE DRAWINGS

FIG. 1 shows component including a substrate and a sheet.

FIG. 2 shows component including a substrate and a sheet (left), and a ceramic skin (right).

FIG. 3 shows perspective view of sheet and skin joined via interlocking members and features.

FIG.4 shows a top view of sheet and skin joined via interlocking members and features.

FIG. 5 shows a flow chart diagram illustrating an embodiment of a method, according to an exemplary embodiment of the present disclosure.

Wherever possible, the same reference numbers will be used throughout the drawings to represent the same parts.

### DETAILED DESCRIPTION OF THE INVENTION

The detailed description set forth below in connection with the appended drawings where like numerals reference like elements is intended as a description of various embodiments of the disclosed subject matter and is not intended to represent the only embodiments. Each embodiment described in this disclosure is provided merely as an example or illustration and should not be construed as preferred or advantageous over other embodiments. The illustrative examples provided herein are not intended to be exhaustive or to limit the claimed subject matter to the precise forms disclosed.

Provided are exemplary high temperature components having hybrid coating systems, and methods for forming hybrid coating system for use, for example, in the hot gas path of a gas turbine. Embodiments of the present disclosure, in comparison to articles and methods not utilizing one or more features disclosed herein, enables thick coating systems, enables coating systems with cooling channels, enables higher firing temperatures, enables lower cooling air, enables simpler and cheaper structural materials, enables engaging small sectionals and/or large pieces of a ceramic skin to the substrate via a sheet in an interlocking manner, or a combination thereof.

All numbers expressing quantities of ingredients and/or reaction conditions are to be understood as being modified in all instances by the term “about”, unless otherwise indicated.

All percentages and ratios are calculated by weight unless otherwise indicated. All percentages are calculated based on the total weight of a composition unless otherwise indicated. All component or composition levels are in reference to the active level of that component or composition, and are exclusive of impurities, for example, residual solvents or by-products, which may be present in commercially available sources.

The articles “a” and “an,” as used herein, mean one or more when applied to any feature in embodiments of the present invention described in the specification and claims. The use of “a” and “an” does not limit the meaning to a single feature unless such a limit is specifically stated. The article “the” preceding singular or plural nouns or noun phrases denotes a particular specified feature or particular specified features and may have a singular or plural connotation depending upon the context in which it is used. The adjective “any” means one, some, or all indiscriminately of whatever quantity.

The term “at least one,” as used herein, means one or more and thus includes individual components as well as mixtures/combinations.

The term “comprising” (and its grammatical variations), as used herein, is used in the inclusive sense of “having” or “including” and not in the exclusive sense of “consisting only of.”

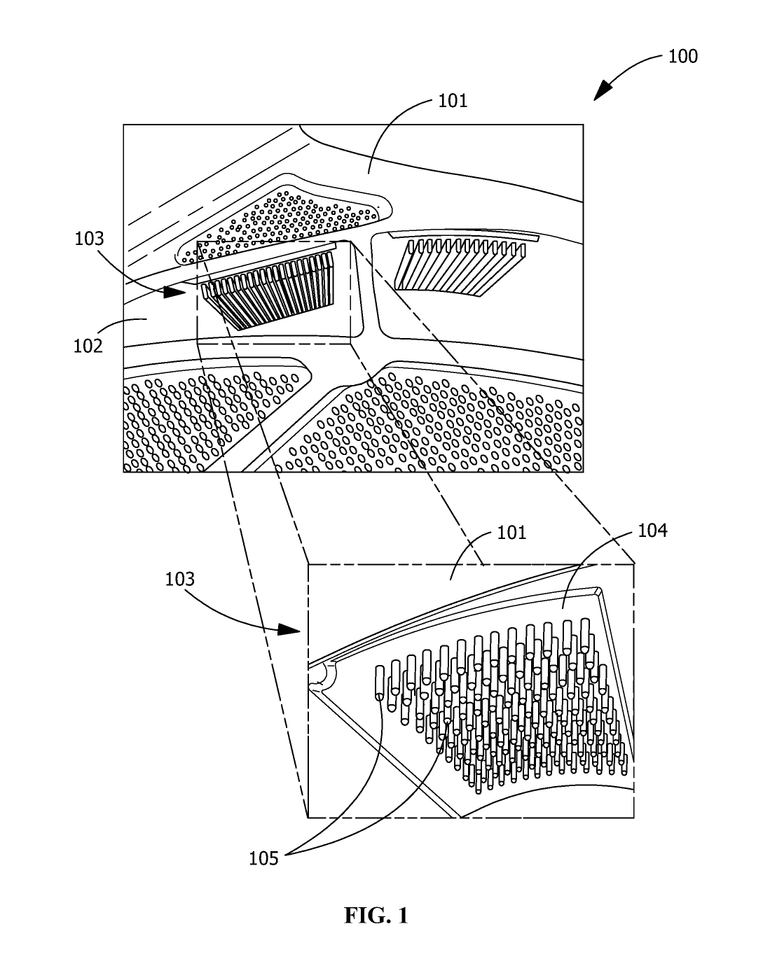

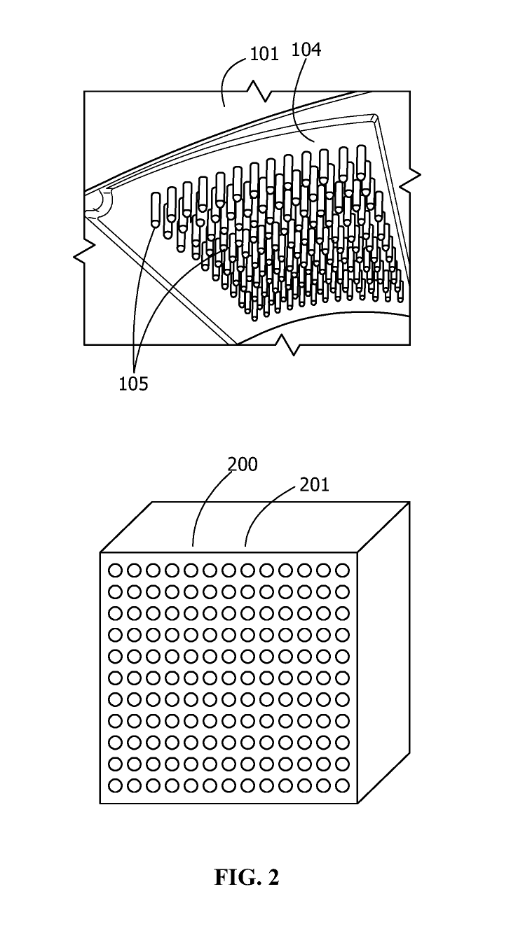

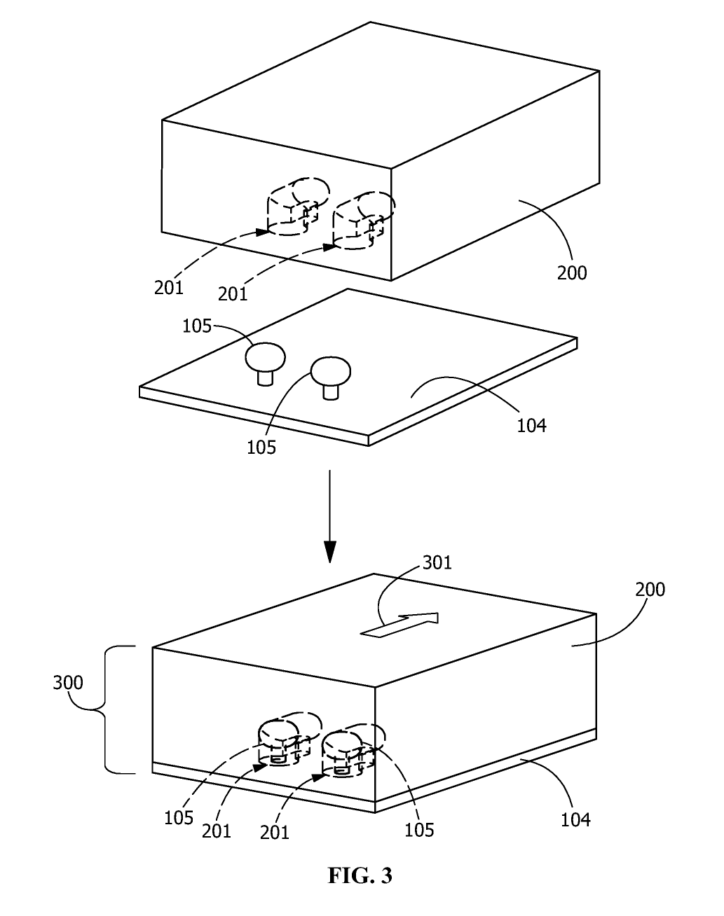

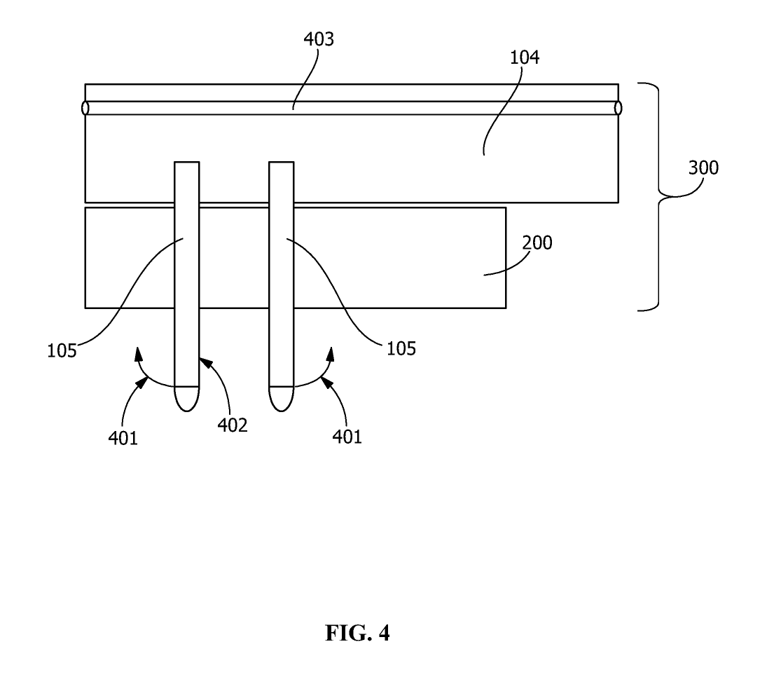

With reference to FIGS. 1 and 2, a component 100 is provided. The component 100 includes a substrate 101 having a surface 102, a sheet 104 disposed on the surface 102 and a skin 200. Enlarged portion 103 shows a magnified view of the sheet 104. The sheet 104 includes a plurality of interlocking members 105. The skin 200 includes a plurality of features 201 corresponding to the interlocking members 105. The skin 200 is engageable with the sheet 104 in an interlocking manner via the interlocking members 105 and the features 201 to form a hybrid coating system 300 (see for example FIGS. 3 and 4). In one embodiment, the skin 200 is engaged to the sheet 104 mechanically via the interlocking members 105 and the features 201. In some embodiments, the skin 200 is engaged to the sheet 104 via both mechanical joining and metallurgical bonding. The metallurgical bonding may be formed by a method including but not limited to welding or brazing. In another embodiment, skin 200 and interlocking members 105 are engaged by an interference fit. The component 100 may further include an additional ceramic layer thermally sprayed onto the skin 200 in order to create a smooth surface if necessary.

In some embodiments, the component 100 includes a substrate 101, a plurality of interlocking members 105, and a skin 200. The skin 200 is engaged to the component 100 in an interlocking manner via the interlocking members 105 and the features 201. Thus, in these embodiments, the interlocking members are part of the component 100, thereby avoiding the need for the sheet 104.

The substrate 101 is composed of a material selected from the group consisting of ceramic, ceramic coated metal, and combinations thereof. The ceramic may be present in the form of continuous fibers, chopped fibers, such as microfibers or nanofibers, or ceramic matrix composite. The ceramic includes, but not limited to, an alumina (Al₂O₃), silicon carbide (SiC), silicon nitride (Si₃N₄), a silicon carbide (SiC) fiber-reinforced silicon carbide (SiC) matrix composite, carbon fiber- reinforced silicon carbide (SiC) matrix composite, a silicon carbide (SiC) fiber-reinforced silicon nitride (Si₃N₄) composite, yttria-stabilized zirconia (YSZ), Scandia-stabilized zirconia (SSZ), calcia-stabilized zirconia (CSZ), or combinations thereof. The ceramic may be fabricated via investment casting, forging, or 3D printing.

In some embodiments, the substrate 101 may be fabricated from any suitable metal or alloy. For example, suitable metals for use as substrate 101 include but are not limited to superalloys. In particular, substrate 101 may include nickel-based, cobalt-based, iron-based or titanium-based superalloys.

In some embodiments, the substrate 101 may include, but not be limited to, a single crystal (SX) material, a directionally solidified (DS) material, an equiaxed crystal (EX) material, and combinations thereof.

The sheet 104 may include, but not be limited to a superalloy, a pre-sintered preform (PSP), or combinations thereof. The pre-sintered preform may be formed from the particulate. As used herein, “pre-sintered preform” or “PSP” refers to a component or a composition formed from a blend of a superalloy and a braze powder.

The sheet 104 may be brazed to the substrate 101. The interlocking members 105 may include, but not be limited to, a superalloy, a pre-sintered preform (PSP), or combinations thereof. The interlocking members 105 may include a spike, a hook, a stud, a lock, or combinations thereof. In one embodiment, the sheet 104 includes a material that is the same as a material of the interlocking members 105. In another embodiment, the sheet 104 includes a material that is dissimilar from a material of the interlocking members 105.

The sheet 104 is composed of a material selected from the group consisting of a metal, ceramic, metal coated ceramic, ceramic coated metal, and combinations thereof. The ceramic may be present in the form of chopped fibers, such as microfibers and nanofibers. The ceramic includes, but not limited to, an alumina (Al₂O₃), a silicon carbide (SiC), silicon nitride (Si₃N₄), a silicon carbide (SiC) fiber-reinforced silicon carbide (SiC) matrix composite, carbon fiber- reinforced silicon carbide (SiC) matrix composite, a silicon carbide (SiC) fiber-reinforced silicon nitride (Si₃N₄) composite, yttria-stabilized zirconia (YSZ), Scandia-stabilized zirconia (SSZ), calcia-stabilized zirconia (CSZ), or combinations thereof.

The skin 200 is composed of material selected from the group consisting of ceramic, ceramic coated metal, and combinations thereof. In some embodiments, the ceramic may be present in the form of chopped fibers, such as microfibers and nanofibers. The ceramic includes, but not limited to, an alumina (Al₂O₃), a silicon carbide (SiC), silicon nitride (Si₃N₄), a silicon carbide (SiC) fiber-reinforced silicon carbide (SiC) matrix composite, carbon fiber- reinforced silicon carbide (SiC) matrix composite, a silicon carbide (SiC) fiber-reinforced silicon nitride (Si3N4) composite, yttria-stabilized zirconia (YSZ), Scandia-stabilized zirconia (SSZ), calcia-stabilized zirconia (CSZ), or combinations thereof.

The skin 200 may be printed by a 3D printing method including binderjet, lithography, digital light processing or combinations thereof. However, the person skilled in the art will appreciate that other 3D printing methods, additive manufacturing, or machining may be used. In some embodiments, the skin 200 comprising SiC/SiC composites may be manufactured via lay-up/infiltration techniques. The skin 200 may further be sintered to be consolidated. After shape is printed, then powder metallurgy processing is done to finish consolidation. The skin 200 may include, but not be limited, to a near net shape. As used herein, the phrase “near-net” refers to being of a geometry and size requiring little or no machining and processing after additive manufacturing. As used herein, the phrase “near net shape” refers to being of a geometry and size requiring little or no machining or processing after additive manufacturing. The skin 200 may include small sectionals, large pieces, or combinations thereof. The features 201 may include a spike, a hook, a pin, a stud, a lock, or combinations thereof. The skin 200 functions as a thermal barrier coating (TBC) for a metal and an environmental barrier coating (EBC) for a ceramic matrix composite (CMC). In one embodiment, the skin 200 includes a material that is the same as a material of the features 201. In another embodiment, the skin 200 includes a material that is dissimilar from a material of the features 201.

The skin 200 shows low thermal conductivity, high strength, high erosion resistance, and high thermal stability.

In some embodiments, interlocking members 105 have a higher thermal expansion coefficient than features 201 do. At room temperature, the joint of interlocking members 105 and features 201 is loose. In high-temperature working conditions, such as the operating temperature of a gas turbine, however, external dimension of interlocking members 105 slightly exceeds the internal dimension of features 201, thereby forming a fit so called an interference fit.

With reference to FIG. 3, the sheet 104 includes interlocking members 105 having a lock or hook (a substrate not shown). The interlocking members 105 can be inserted to the features 200. The skin 200 may slide in the direction 301 to join the interlocking members 105. In some embodiments, the sheet 104 may have plural interlocking members 105 and the skin 200 may have plural features 201. In another embodiment, the feature may include a geometry that receives the interlocking member 105 and rotates to engage and join the sheet 104 to the skin 200. With reference to FIG. 4, the sheet 104 includes interlocking members 105 having a pin (a substrate not shown). The interlocking members 105 pierce through the skin 200. The skin 200 has corresponding features or aperature, such as an aperature that permits passage of the interlocking members 105. The protruding portion 402 of the interlocking members 105 can be bent toward the surface of the skin 200 in the direction 401. In some embodiments, the sheet 104 may have plural interlocking members 105 and the skin 200 may have plural features 200. In some embodiments, the protruding portion 402 of interlocking members 105 are spot welded to the skin 200. Also shown in FIG. 4, the skin 200 may optionally include a cooling passage 403 to permit flow of fluid, such as cooling fluid.

In some embodiments, the skin 200 may include cooling air inlet holes, cooling air exit holes, cooling channels, or combinations thereof. In an embodiment, the skin 200 may not include cooling air inlet holes, cooling air exit holes, cooling channels, and combinations thereof.

In one embodiment, the skin 200 may be joined to the sheet 104 so that little or no gap is formed. In another embodiment, the skin 200 may be joined to the sheet 104 with a gap, which functions as cooling plenum that can be pressurized via cooling air supply.

In some embodiments, the gap is between 0.01 inch and 0.125 inch. In some embodiments, the gap is between 0.02 inch and 0.115 inch. In some embodiments, the gap is between 0.03 inch and 0.105 inch. In some embodiments, the gap is between 0.04 inch and 0.095 inch. In some embodiments, the gap is between 0.05 inch and 0.085 inch. In some embodiments, the gap is between 0.06 inch and 0.075 inch.

In some embodiments, a component 100 is a turbine component. The turbine component may include airfoils, buckets, blades, nozzles, vanes, shrouds, rotating turbine components, wheels, seals, combustor liners, 3D-manufactured components and transition ducts. The turbine component includes a substrate 101 having a surface 102, a sheet 104 disposed on the surface 102 and a skin 200. The substrate 101 may include a metal, ceramic matrix composite (CMC), or combinations thereof. The sheet 104 includes a plurality of interlocking members 105. The skin 200 having a plurality of features 201 corresponding to the interlocking members 105. The skin 200 is engaged to the sheet 104 in an interlocking manner via the interlocking members 105 and the features 201. The sheet 104 is brazed or welded to the substrate 101. The component 100 may further include an additional ceramic layer thermally sprayed onto the ceramic skin. In one embodiment, the skin 200 includes a material that is the same as a material of the additional ceramic layer. In another embodiment, the skin 200 includes a material that is dissimilar from a material of the additional ceramic layer.

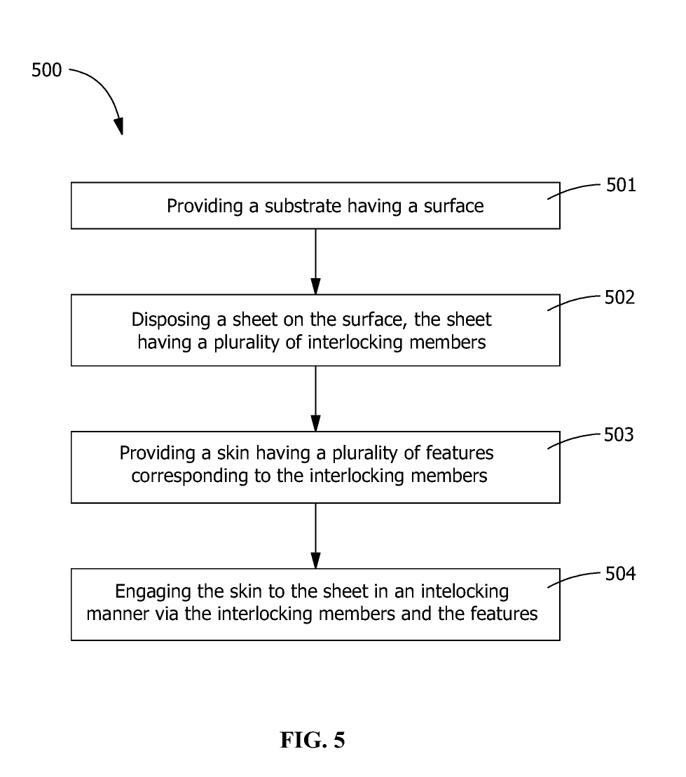

With reference to FIG. 5, a process 500 is provided. In one embodiment, the process 500 includes the step of providing a substrate 101 having a surface 102 (step 501). The process 500 further includes the step of disposing a sheet 104 on the surface, the sheet 104 having a plurality of interlocking members 105 (step 502). The process 500 also includes the step of providing a skin 200 having a plurality of features 201 corresponding to the interlocking members 105 (step 503). The process 500 further includes the step of engaging the skin 200 to the sheet 104 in an interlocking manner via the interlocking members 105 and the features 201 (step 504).

After the component 100 experiences a certain amount of thermal cycling, the old skin 200 may be replaced by a new skin.

While the invention has been described with reference to a preferred embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A component having a hybrid coating system, the component comprising:
a substrate having a surface;
a plurality of interlocking members;
the hybrid coating system comprising:
a skin, the skin having a plurality of features corresponding to the interlocking members,
wherein the skin is engaged to the component in an interlocking manner via the interlocking members and the features.

2. The component of claim 1, wherein the hybrid coating system further comprises
a sheet disposed on the surface, the sheet having the plurality of interlocking members; and
wherein the skin is engaged to the sheet in an interlocking manner via the interlocking members and the features.

3. The component of claim 1, wherein the substrate comprises a material selected from the group consisting of a metal, ceramic, metal coated ceramic, ceramic coated metal, and combinations thereof.

4. The component of claim 1, wherein the sheet comprises a material selected from the group consisting of a metal, ceramic, metal coated ceramic, ceramic coated metal, and combinations thereof.

5. The component of claim 1, wherein the sheet and interlocking members comprise materials selected from the group consisting of a superalloy and pre-sintered preform (PSP).

6. The component of claim 1, wherein the skin includes cooling air inlet holes, cooling air exit holes, cooling channels, and combinations thereof.

7. The component of claim 1, wherein the skin does not include cooling air inlet holes, cooling air exit holes, cooling channels, and combinations thereof.

8. The component of claim 1, wherein the skin comprises a material selected from ceramic, ceramic coated metal, and combinations thereof.

9. The component of claim 1, wherein the skin is a near net shape.

10. The component of claim 1, wherein the component further includes an additional ceramic layer.

11. A turbine component, having a hybrid coating system, the component comprising:
a substrate having a surface, the substrate comprising a material selected from the group consisting of a metal, ceramic, metal coated ceramic, ceramic coated metal, and combinations thereof;
the hybrid coating system comprising:
a sheet disposed on the surface, the sheet having a plurality of interlocking members, and the sheet comprising a material selected from the group consisting of a metal, ceramic, metal coated ceramic, ceramic coated metal, and combinations thereof; and
a skin, the skin having a plurality of features corresponding to the interlocking members, and the skin comprising a material selected from ceramic, ceramic coated metal, and combinations thereof,
wherein the skin is engaged to the sheet in an interlocking manner via the interlocking members and the features, and
wherein the component further includes an additional ceramic layer.

12. A process for forming a component having a hybrid coating system, comprising:
providing a substrate having a surface and a plurality of interlocking members;
providing a skin having a plurality of features corresponding to the interlocking members; and
engaging the skin to the component in an interlocking manner via the interlocking members and the features.

13. The process of claim 12, further comprising
disposing a sheet on the surface, the sheet having the interlocking members,
wherein the skin is engaged to the sheet in an interlocking manner via the interlocking members and the features.

14. The process of claim 12, wherein the substrate comprises a material selected from the group consisting of a metal, ceramic, metal coated ceramic, ceramic coated metal, and combinations thereof.

15. The process of claim 12, wherein the sheet comprises a material selected from the group consisting of a metal, ceramic, metal coated ceramic, ceramic coated metal, and combinations thereof.

16. The process of claim 12, wherein the sheet and interlocking members comprise materials selected from the group consisting of a superalloy, pre-sintered preform (PSP), and combinations thereof.

17. The process of claim 12, wherein the skin includes cooling air inlet holes, cooling air exit holes, cooling channels, and combinations thereof.

18. The process of claim 12, wherein the skin is printed by a method selected from the group consisting of binderjet, lithography, digital light processing, lay-up/infiltration and combinations thereof.

19. The process of claim 12, further comprising thermally spraying an additional ceramic layer onto the skin.

20. The process of claim 12, wherein the sheet is brazed or welded to the substrate.
